(19) United States
(12) Patent Application Publication
(10) Pub. No.: US 2015/0140207 A1
(43) Pub. Date: May 21, 2015

(54) METHOD FOR PREPARING ELECTROMAGNETIC WAVE SHIELDING MATERIAL

(71) Applicant: Gwangju Institute of Science and Technology, Gwangju (KR)

(72) Inventors: Myung-Han YOON, Gwangju (KR); Sukwon HONG, Gwangju (KR); Zahid HANIF, Gwangju (KR); Seyeong LEE, Gwangju (KR)

(21) Appl. No.: 14/548,038

(22) Filed: Nov. 19, 2014

(30) Foreign Application Priority Data
Nov. 20, 2013 (KR) 10-2013-0141052

(51) Int. Cl. H01F 41/24

(52) U.S. Cl. CPC H01F 41/24
USPC 427/130

(57) ABSTRACT

Disclosed herein is a method for preparing an electromagnetic wave shielding material. The preparation method includes: preparing a fiber matrix; sorbing a metal salt precursor to the fiber matrix by dip coating; and bringing the fiber matrix to which the metal salt precursor is sorbed with a basic solution to oxidize the metal salt precursor such that a magnetic substance can be coated onto the fiber matrix. The method can reduce preparation costs by simplifying the preparation process through dip coating without using a high temperature process. Further, the method can also be applied to a fiber matrix which can be affected by temperature, thereby enlarging the preparation and application range of the electromagnetic wave shielding material.

### CROSS REFERENCE TO RELATED APPLICATION

This application claims priority to Korean Patent Application No. 10-2013-0141052 on 20 Nov. 2013, and all the benefits accruing therefrom under 35 U.S.C. §119, the contents of which is incorporated by reference in its entirety.

### BACKGROUND

1. Technical Field

The present invention relates to a method for preparing an electromagnetic wave shielding material. More particularly, the present invention relates to a method for preparing an electromagnetic wave shielding material using dip coating.

2. Description of the Related Art

As electronic technology rapidly developments and the number of electronic communication apparatuses sharply increases, there has been controversy over the harmfulness of electromagnetic waves generated by electronic communication apparatuses. Such harmfulness is mainly caused by high frequency electromagnetic waves generated from electronic components used in the electronic communication apparatuses. Such electromagnetic waves cause electromagnetic interference, which also causes unnecessary electromagnetic signal or noise, thereby problems such as interference of electromagnetic signals, malfunction of electronic components, and the like. Since it is reported that such electromagnetic waves affect not only electronic components but also the human body, various studies have been conducted to shield such electromagnetic waves. The studies for shielding electromagnetic waves are conducted based on a method for reflecting or absorbing low impedance electromagnetic fields, which are guided waves generated in electronic components to which voltage is applied.

Conventional electromagnetic wave shielding materials are generally prepared by adding a metal such as iron and nickel to organic fibers such as metal fibers, plastics, carbon nanotubes, graphene and the like, and then used to form conductive fibers, conductive meshes, conductive films, and the like. However, since such a method of preparing an electromagnetic wave shielding material is composed of a high temperature heat treatment process and a complex process, there are problems such as a long preparation time, high manufacturing costs, and difficulty in mass production. In addition, the high temperature heat process causes deterioration in physical properties of polymers when the shielding material is based on polymers susceptible to temperature.

### BRIEF SUMMARY

It is an aspect of the present invention to provide a method for preparing an electromagnetic wave shielding material through a simple process without a high temperature process.

In accordance with one aspect of the present invention, a method for preparing an electromagnetic wave shielding material includes: preparing a fiber matrix; sorbing a metal salt precursor to the fiber matrix by dip coating; and bringing the fiber matrix to which the metal salt precursor is sorbed with a basic solution to oxidize the metal salt precursor such that a magnetic substance can be coated onto the fiber matrix.

According to the present invention, it is possible to reduce preparation costs by simplifying the preparation process through dip coating without using a high temperature process.

Further, the method according to the present invention can also be applied to a fiber matrix which can be affected by temperature, thereby enlarging the preparation and application range of the electromagnetic wave shielding material.

### BRIEF DESCRIPTION OF THE DRAWINGS

The above and other aspects, features, and advantages of the present invention will become apparent from the detailed description of the following embodiments in conjunction with the accompanying drawings;

FIG. 1 is a flowchart of a method of preparing an electromagnetic wave shielding material according to one embodiment of the present invention;

FIG. 2a is an SEM image of cellulose before coating with a magnetic substance, and FIG. 2b is an SEM image of cellulose coated with a magnetic substance in Example 1; and

FIG. 3 shows a graph comparing an electromagnetic wave shielding rate of a conductive polymer (polypyrrole)-coated matrix coated with a magnetic substance (Fe₃O₄) in Example 2 with that of a conductive polymer (polypyrrole)-coated matrix not coated with the magnetic substance.

### DETAILED DESCRIPTION

Hereinafter, embodiments of the present invention will be described in detail with reference to the accompanying drawings.

It should be understood that the following embodiments are provided for illustration only and are not to be construed in any way as limiting the present invention, and that various modifications, changes, alterations, and equivalent embodiments can be made by those skilled in the art without departing from the spirit and scope of the invention.

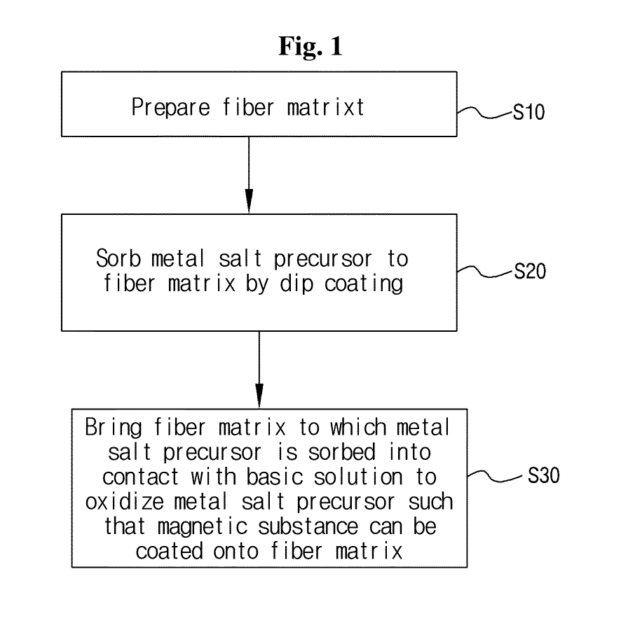

FIG. 1 is a flowchart of a method of preparing an electromagnetic wave shielding material according to one embodiment of the present invention.

First, a fiber matrix is prepared (S10).

The fiber matrix may include at least one selected from cellulose, polyester fibers, nylon, and conductive polymers.

Cellulose is a primary structural component of the cell wall of plants and consists of closely packed glucans. Thus, cellulose is very stable and has tough properties. Further, cellulose is an environmentally friendly and natural fiber, and contributes to cost savings in preparation of the electromagnetic wave shielding material. Cellulose may be crystalline cellulose.

Polyester is the most widely used synthetic fibers and can be obtained by melt spinning poly(ethylene terephthalate). Such polyester fibers have high strength together with flexibility and can be coated with a magnetic material. Thus, the polyester fibers may be advantageously used as an electromagnetic wave shielding material.

Nylon refers to polyamide-based synthetic fibers, and has high strength and is not affected by bacteria and the like. Thus, like polyester fibers, nylon may also be advantageously used as an electromagnetic wave shielding material. Nylon may be passed through a separate purification process including washing and drying in order to remove by-products introduced during the manufacture of the fiber matrix.

The conductive polymer may include at least one selected from polypyrrole, polyacetylene, polythiophene, polyisothianaphthalene, polyethylene dioxythiophene, polyparaphenylene vinylene, poly(2,5-dialkoxy)paraphenylene vinylene, polyparaphenylene, and polyheptadiene.

In the present method, a metal salt precursor is sorbed to the fiber matrix by dip coating (S20).

In dip coating, the fiber matrix is immersed in a metal salt precursor solution (S21).

The metal salt precursor solution is selected from a compound including metal components or a mixture thereof. The metal salt precursor solution may include at least one selected from Fe, Ni, Cu, Ag, Co, Sn, Pd, Au, or alloys thereof. Water may be used as a solvent for the metal salt precursor solution. When the fiber matrix is immersed in the metal salt precursor solution, the metal salt precursor may be sorbed to the fiber matrix. The step of immersing the fiber matrix in the metal salt precursor solution may be performed at room temperature. Unlike a typical process for preparing an electromagnetic wave shielding material in which a metal layer is formed on a corresponding substrate through a high temperature process, the method of the present invention is conducted without a high temperature process and thus the preparation process is not complex, thereby reducing manufacturing costs. Further, by virtue of not passing through such a high temperature process, the method of the present invention may be applied to natural fibers such as cellulose, which is difficult to use in a high temperature process in the past, thereby further reducing manufacturing costs. As a result, application ranges of the electromagnetic wave shielding material can be enlarged.

The thickness of the finally coated magnetic substance may be determined by changing the concentration of the metal salt precursor solution. The concentration of the metal source in the metal salt precursor solution may be, for example, 0.01M to 0.1M.

The immersed fiber matrix is dried (S22).

As water acting as the solvent for the metal salt precursor solution is evaporated, the metal salt precursors can remain on the fiber matrix. Dying may be performed by slowly drying the immersed fiber matrix at room temperature. Since the fiber matrix has a hydrophobic surface and thus rapid drying is not smoothly performed, drying may be conducted as slowly as possible.

Dip coating may be conducted about 2-10 times more. Since the fiber matrix can have a hydrophobic surface as mentioned above, the coating process may be conducted 2-10 times more in order to increase yield of a magnetic substance to be coated. However, such a coating number is not particularly limited so long as coating is performed such that the magnetic substance can be sufficiently formed on the fiber matrix.

The fiber matrix to which the metal salt precursor is sorbed is brought into contact with a basic solution to oxidize the metal salt precursor such that the magnetic substance can be coated onto the fiber matrix (S30).

As the sorbed metal salt precursor is oxidized by the basic solution, the magnetic substance may be coated on the fiber matrix to which the metal salt precursor is sorbed. The process of bringing the fiber matrix into contact with the basic solution may be performed at 70° C. or less.

After the fiber matrix to which the metal salt precursor is sorbed is brought into contact with the basic solution, washing and drying may be performed. Washing may be performed using, for example, acetone and water. Drying may be performed at room temperature or using a drying device.

The fiber matrix coated with the magnetic substance according to one embodiment of the invention may have high conductivity and thus reduces generation of electromagnetic waves through reflection, multiple reflection, absorption loss, and grounding, whereby the fiber matrix coated with the magnetic substance can be used as an electromagnetic wave shielding material.

### EXAMPLES

### Example 1

### Preparation of Cellulose Coated With Magnetic Substance

A metal salt precursor solution containing FeCl₃ and FeCl₂ in a concentration ratio of 2:1 was prepared. Cellulose was immersed in the metal salt precursor solution to sorb metal salts consisting of FeCl₃ and FeCl₂ onto the cellulose. Subsequently, the immersed cellulose was dried in air. The dried cellulose was brought into contact with an aqueous ammonia solution at 60° C. for five minutes to oxidize the metal salts. Then, the resulting material was subjected to washing with ethanol and water, and drying in air to obtain cellulose coated with a magnetic substance.

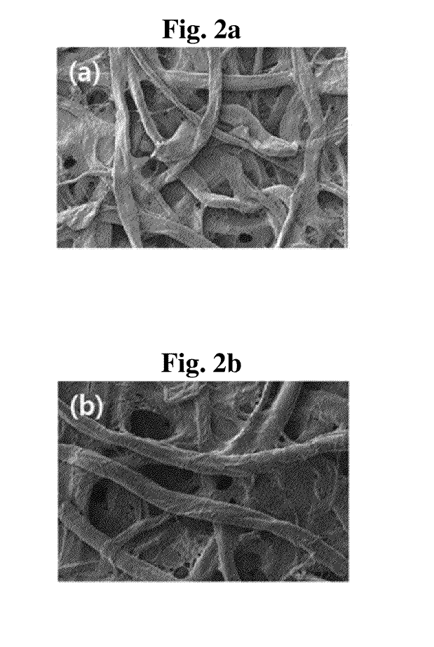

FIG. 2a is an SEM image of cellulose before coating with a magnetic substance, and FIG. 2b is an SEM image of cellulose coated with a magnetic substance according to Example 1 of the present invention.

In FIG. 2a and FIG. 2b, it can be seen that the color of the matrix of FIG. 2b, which was cellulose coated with the magnetic substance in Example 1, was changed to black. From this result, it can be seen that the magnetic substance was evenly coated onto the surface of the cellulose through dip coating without using a high temperature process.

### Example 2

### Preparation of Cellulose Coated With Magnetic Substance and Polypyrrole

A metal salt precursor solution containing FeCl₃ was prepared. Cellulose was immersed in the metal salt precursor solution. The cellulose to which a metal salt consisting of FeCl₃ was sorbed was placed in a deposition chamber, and a polypyrrole monomer was coated onto the surface of cellulose by vapor deposition. The cellulose coated with polypyrrole was washed with ethanol and water, followed by drying in air. Subsequently, the dried cellulose was immersed in a metal salt precursor solution containing FeCl₃ and FeCl₂, dried in air and brought into contact with an aqueous ammonia solution at 60° C. for five minutes to oxidize the metal salts. Then, the resulting material was subjected to washing and drying in air, thereby preparing cellulose, the polypyrrole-coated surface of which was coated with a magnetic substance (Fe₃O₄).

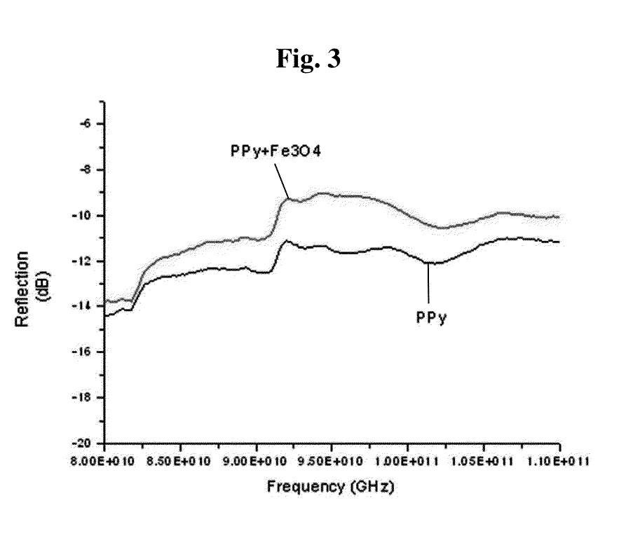

FIG. 3 shows a graph comparing an electromagnetic wave shielding rate of a matrix having a conductive polymer (polypyrrole) coating layer coated with a magnetic substance (Fe₃O₄) in Example 2 with that of a matrix having a conductive polymer (polypyrrole) coating layer not coated with the magnetic substance.

Referring to FIG. 3, the x axis represents frequencies of electromagnetic waves and the y axis represents the degree of reflection of the matrix. It could be seen that the conductive polymer (polypyrrole)-coated matrix coated with a magnetic substance (Fe₃O₄) in Example 2 showed an increased electromagnetic wave shielding rate throughout the overall frequency range, as compared with the conductive polymer (polypyrrole)-coated matrix not coated with a magnetic substance. This means that the matrix coated with the magnetic substance (Fe₃O₄) can efficiently reflect electromagnetic waves applied thereto. This also indicates that the matrix coated with the magnetic substance (Fe₃O₄) has an increased electromagnetic wave shielding rate. From these results, it can be seen that the conductive polymer-coated matrix coated with the magnetic substance in Example 2 showed an increased electromagnetic wave shielding rate.

Although the present invention has been described with reference to some embodiments in conjunction with the accompanying drawings, it should be understood that the foregoing embodiments are provided for illustration only and are not to be construed in any way as limiting the present invention, and that various modifications, changes, alterations, and equivalent embodiments can be made by those skilled in the art without departing from the spirit and scope of the invention.

What is claimed is:

1. A method for preparing an electromagnetic wave shielding material, comprising:
preparing a fiber matrix;
sorbing a metal salt precursor to the fiber matrix by dip coating; and
bringing the fiber matrix, to which the metal salt precursor is sorbed, with a basic solution to oxidize the metal salt precursor such that a magnetic substance can be coated onto the fiber matrix.

2. The method according to claim 1, wherein the fiber matrix comprises at least one selected from cellulose, polyester fibers, nylon, and conductive polymers.

3. The method according to claim 1, wherein the basic solution comprises at least one selected from ammonia (NH₃), potassium hydroxide (KOH), sodium hydroxide (NaOH), sodium carbonate(Na₂CO₃), ammonium hydroxide(NH₄OH), ammonium carbonate((NH₄)₂CO₃) and potassium carbonate(K₂CO₃).

4. The method according to claim 1, wherein dip coating the fiber matrix comprises immersing the fiber matrix in a metal salt precursor solution and drying the immersed fiber matrix.

5. The method according to claim 4, wherein the metal salt precursor solution comprises at least one selected from Fe, Ni, Cu, Ag, Co, Sn, Pd, Au, or alloys thereof.

6. The method according to claim 1, wherein bringing the fiber matrix into contact with the basic solution is performed at 70° C. or less.
